(19) United States
(12) Patent Application Publication
(10) Pub. No.: US 2018/0318926 A1
(43) Pub. Date: Nov. 8, 2018

(54) ADDITIVE MANUFACTURING APPARATUS

(71) Applicant: Xact Metal, Inc., State College, PA (US)

(72) Inventor: Matthew Woods, State College, PA (US)

(21) Appl. No.: 15/585,477

(22) Filed: May 3, 2017

(51) Int. Cl. B22F 3/105; B33Y 10/00; B33Y 30/00; B33Y 50/02; B23K 26/342; B23K 26/04; B23K 26/082; B23K 26/06

(52) U.S. Cl. CPC B22F 3/1055; B33Y 10/00; B33Y 30/00; B33Y 50/02; B23K 26/342; B23K 2203/05; B23K 26/0821; B23K 26/0643; B23K 26/082; B23K 26/0648; B22F 2003/1057; B23K 26/04

(57) ABSTRACT

We disclose herein an apparatus for an additive manufacturing process, the apparatus comprising: a structure for providing a target area for producing a 3D part; a gantry device located on top of the target area of the structure, wherein the gantry device comprises: a first primary reflecting element for receiving a collimated beam from a light source; a first secondary reflecting element for receiving at least a portion of said collimated beam from the first primary reflecting element; a first scanner comprising a focal element for directing the at least a portion of said collimated beam to the target area, wherein the apparatus further comprises a controller configured to move the first scanner of the gantry device over the target area in a first direction along a longitude of the apparatus and in a second direction transverse to the first direction.

### FIELD OF THE INVENTION

The present invention relates to an additive manufacturing apparatus, particularly but not exclusively, to a metal three dimensional (3D) printing device.

### BACKGROUND

Additive Manufacturing (AM) can be used to create complex parts quickly and efficiently. In the field of AM, Selective Laser Melting (SLM) is a type of Powder Bed Fusion (PBF) process that can be used to fuse metal powder particles together, layer by layer, to build fully-dense metal parts. An SLM system is typically comprised of a build piston, a feed cylinder, a wiper/recoating mechanism, and a high powered laser scanner.

Method and apparatus for selective laser sintering (SLS) are described in U.S. Pat. No. 4,938,816. Layers of powder are selectively sintered and parts are produced, comprising a plurality of layers, by applying powder to sintered layers. A directing mechanism moves the laser beam to the part of the layer to be sintered. This mechanism may use a pair of mirrors driven by galvanometers, known as a galvo scanner. The first mirror reflects the laser beam to the second mirror which reflects the beam to the target area. Movement of the first mirror shifts the laser beam in a first direction while movement of the second mirror shifts the laser beam in a second direction orthogonal to the first direction.

SLS has the disadvantage that it cannot be used to make metal components that withstand high temperatures and high stress. The metal must be sheathed by a sinterable material or be in a powder mixture with a material with a lower melting point. These other materials act as a binding agent for the metal particles.

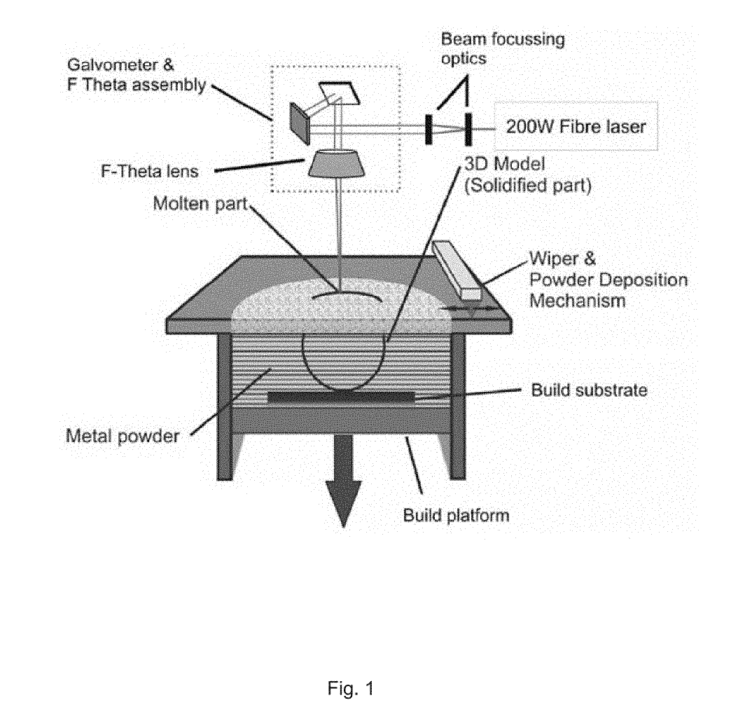

In SLM the metallic powder is free of binding agents and a laser beam heats the metal to melting temperature. SLM is described in U.S. Pat. No. 6,215,093. A SLM device using a galvo scanner is shown in FIG. 1. The scanner does not move however the mirrors are used to direct the laser beam to different areas by changing the angle of incidence (AOI) of the laser with the build plate. As the AOI increases, so does the distance from the lens to the build surface. The focal length cannot be constant, requiring an expensive f-theta lens. The f-theta lens creates a planar focal length such that no matter what angle the beam travels through, it will always focus on the same plane. The AOI changes over the area of the build plate. As such, part quality is subject to variation based on location within the build plate. There is a finite limit on scan area imposed by the limitations of the f-theta lens. In order to cover build areas larger than the f-theta lens can reach, multiple scanners must be used. However, the use of multiple scanners increases the costs significantly. Furthermore, the f-theta lens requires a greater distance from the build plane for reasonable sized scan areas. This means that a larger and more expensive build chamber is necessary, requiring more consumable inert gas to fill the build chamber.

U.S. Pat. No. 9,011,136 describes a multi-head AM device. The device uses multiple writing heads to simultaneously write different segments of an object. The system used to move the writing heads in this device requires a separate motor for each direction, one which must be mounted on a moving carriage. The writing heads of this device are independently driven which may also increase moving mass. The carriages are configured to slide along a track by use of an actuating mechanism. This actuating mechanism comprises a motor that drives a screw and moves a nut connected to a carriage.

US Publication No. 2013/0078073 describes a gantry assembly for use in an extrusion based AM system. This gantry system is known as the H-bot gantry system. The gantry is driven by two fixed drive pulleys. However, the layout of the H-bot gantry system causes a torque on the on the moving axis. Consequently, H-bot gantries that are not perfectly rigid will exhibit a flex. This flex generally limits the quality of the parts manufactured.

### SUMMARY

According to one aspect of the present invention, there is provided an apparatus for an additive manufacturing process to fuse metal powder particles for building a 3D metal part, the apparatus comprising: a structure for providing a target area for producing the 3D metal part; a gantry device located on top of the target area of the structure, wherein the gantry device comprises: a first primary reflecting element for receiving a collimated beam from a light source; a first secondary reflecting element for receiving at least a portion of said collimated beam from the first primary reflecting element; a first scanner comprising a focal element for directing the at least a portion of said collimated beam to the target area; wherein the apparatus further comprises a controller configured to move the first scanner of the gantry device over the target area in a first direction (or x-direction of a x-y plane) along a longitude of the apparatus and in a second direction (or y-direction of a x-y plane) transverse to the first direction. Here the additive manufacturing is conducted in an SLM device. When a beam splitting device is used in the system, a beam is split into two beams of inversely proportional power levels. This allows for one of the beams, the reflected beam, to propagate along the original path and through the focal lens of a first scan head. The other beam, the transmitted beam, is incident with the secondary reflecting element of a second scanner and propagates through the focal elements of the second scanner. It will be appreciated that the apparatus is not only restricted to 3D printing of metal parts. It is capable of printing 3D parts comprising other materials.

Broadly speaking, the present invention utilises a gantry device (system) generally known as a Core-XY gantry system in combination with SLM scan-heads (or scanners). In the gantry device, both motors are fixed and so moving mass is reduced (minimised). However, the belt of the Core-XY gantry is crossed, reducing (eliminating) unwanted torque on the moving axis. Advantageously the invention provides a significantly lightweight design of the scanner. By removing excess moving mass and retaining the rigidity of the structure, it is possible to attain high scan speeds while maintaining a high degree of precision.

Any axis of the scanner may be extended to reach larger build areas or target areas. Advantageously, this results in a highly scalable design. The scanner can be extended using longer rails and belts without increasing the number of scanners. Therefore the scanner can be designed using reduced costs and complexity.

As the scan head (scanner) is movable in the x-y plane, the AOI is kept constant while still allowing the scanner to reach the whole target area of the build plane. Unlike the galvo based scanner of the prior art, the mirrors are at fixed angles and so there is no need for heavy motors or wiring. This further reduces moving mass in the machine. As the AOI remains constant, an aspheric lens may be used rather than an f-theta lens, thus reducing costs. This reduction in cost does not reduce quality or performance of the scanner. Furthermore, the quality of parts is not subject to variation across the build plane as the AOI remains constant across the entire build plane.

The focussing lens within the scan head does not need to be of large focal length, as it is capable of travelling to any location within the build plane and thus does not need to be capable of covering large angular changes. Minimising the focal length of the lens allows the volume of the build chamber to be reduced. Therefore fabrication of the build chamber is less costly and less inert gas is consumed during the AM process. Furthermore, the weight of the overall machine is reduced.

Additionally, a plurality of scan heads may be used to increase productivity. This scalability enhances cost effectiveness in larger area configurations.

The controller may be configured to move the first scanner in two dimensions of Cartesian space over the target area. The controller may be configured to move the first scanner over any location of the target area. Here the controller is generally controlled by computer programs or code.

The first secondary reflecting element may be positioned such that a reflecting surface is about 45° angle from a direction of beam propagation from the first primary reflecting element. The first primary reflecting element and the first secondary reflecting element each may be a reflecting mirror. When the reflecting mirror is used the entire beam is reflected whereas when a beam splitter is used the beam is split into two beams—one is reflected and another is transmitted.

The gantry device may further comprise a first longitudinal rail (or first linear rail); a first carriage (or a carriage of a first type) moveable along the first longitudinal rail along the first direction; a second longitudinal rail (or a second linear rail); a second carriage (or a carriage of a second type) moveable along the second longitudinal rail (or a second linear rail) along the first direction; a first vertical rail unit (or the third linear rail) connecting the first and second carriages and extending in the second direction. The first scanner may be moveable in the first direction (or a horizontal direction) when the first and second carriages move in the first direction, and wherein the first scanner is moveable along the first vertical rail unit in the second direction (or a vertical direction).

The first primary reflecting element may be coupled with the first carriage and the first secondary reflecting element is coupled with the first scanner. In one embodiment, the first primary reflecting element is mounted on the carriage so that when the carriage moves the reflecting element moves as well.

The apparatus may comprise a second scanner on the first vertical rail unit, wherein the second scanner comprises a second secondary reflecting element. In this example, the first primary reflecting element may be a reflecting mirror and wherein the first secondary reflecting element may be a beam splitter and wherein the second secondary reflecting element may be a reflecting mirror. In this configuration two scanners can be used to improve efficiency of the 3D printer.

The first primary reflecting element may be a reflecting mirror and wherein the first secondary reflecting element may be a beam splitter and wherein the second secondary reflecting element may be a beam splitter. In this configuration, more than two scanners can be used on one vertical rail and thus providing improved efficiency.

The apparatus may further comprise a third carriage moveable along the first longitudinal rail along the first direction; a fourth carriage moveable along the second longitudinal rail along the first direction; a second vertical rail unit connecting the third and fourth carriages extending in the second direction. The apparatus may further comprise a second primary reflecting element coupled with the third carriage.

The apparatus may further comprise a third scanner moveable on the second vertical rail and a third secondary reflecting element coupled with the third scanner, and wherein the first primary reflecting element is a beam splitter, and wherein the second primary reflecting element is a reflecting mirror and the third second reflecting element is a reflecting mirror. In this configuration, it is possible to achieve a two scan heads arrangement in which one scan head is moveable on the first vertical rail and another scan head is moveable on the second vertical rail.

The apparatus may further comprise a fourth scanner moveable on the second vertical rail and a fourth secondary reflecting element coupled with the fourth scanner, and wherein the first primary reflecting element may be a beam splitter, and wherein the second primary reflecting element may be a reflecting mirror, and wherein the third secondary reflecting element may be a beam splitter, and wherein the fourth secondary reflecting element may be a reflecting mirror. In this configuration, it is possible to achieve a four scan heads arrangement in which two scan heads are moveable on the first vertical rail and two other scan heads are moveable on the second vertical rail. These arrangements are generally referred as passive configurations.

The apparatus may further comprise a second primary reflecting element coupled with the fourth carriage, and a third scanner moveable on the second vertical rail and a third secondary reflecting element coupled with the third scanner. The second primary reflecting element may be configured to receive a collimated beam from a further light source. This arrangement is generally referred as an active configuration.

The first and second reflecting elements may not rotate to an angle. The reflecting elements are generally fixed at a particular angle.

The first scanner may comprise a galvanometer based deflection device so that at least one of the first primary and secondary reflecting elements rotates. This arrangement is a hybrid arrangement. This arrangement provides the unconstrained build area dimensions arising from using the Core-XY gantry system with the high scanning and positioning speeds of a galvo scanner. Unlike a conventional galvo scanner, this embodiment reduces the AOI as the scanner does not need to deflect the beam very far. The scanner uses small deflection angles to scan small areas quickly, while the gantry system simultaneously moves the scanner across the build plane. This has the advantage that the mass of the moving parts of the galvo scanner is not a problem as the gantry does not need to move as rapidly as in the previous embodiments. The galvo scanner may replace the scan head in any active configuration of the machine.

The apparatus may further comprise a light source. The apparatus may also comprise a plurality of light sources.

A system for additive manufacturing comprising a light source; and an apparatus as discussed above.

A metal 3D printer incorporating the apparatus described above.

According to a further aspect of the present invention, there is provided a method of manufacturing an apparatus for an additive manufacturing process, the method comprising: providing a structure having a target area for producing a 3D part; providing a gantry device located on top of the target area of the structure, wherein the gantry device comprises: a first primary reflecting element for receiving a collimated beam from a light source; a first secondary reflecting element for receiving at least a portion of said collimated beam from the first primary reflecting element; a first scanner comprising a focal element for directing the at least a portion of said collimated beam to the target area; and providing a controller to move the first scanner of the gantry device over the target area in a first direction along a longitude of the apparatus and in a second direction transverse to the first direction.

### BRIEF DESCRIPTION OF THE PREFERRED EMBODIMENTS

Some preferred embodiments of the invention will now be described by way of an example only and with reference to the accompanying drawings, in which:

FIG. 1 illustrates a conventional SLM device with a galvanometer based deflection system;

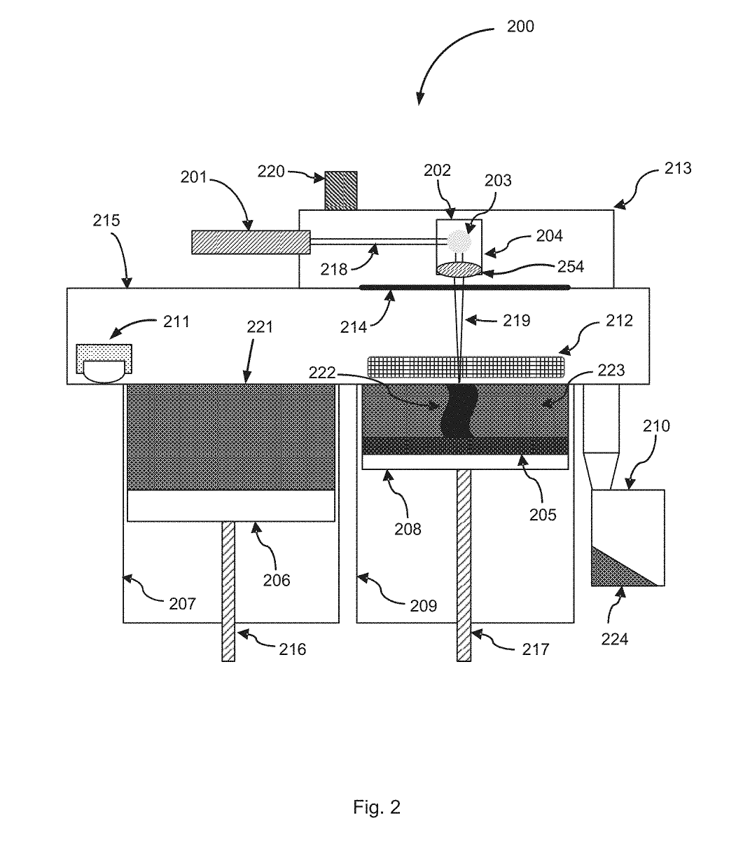

FIG. 2 is a schematic representation of an embodiment of an SLM machine;

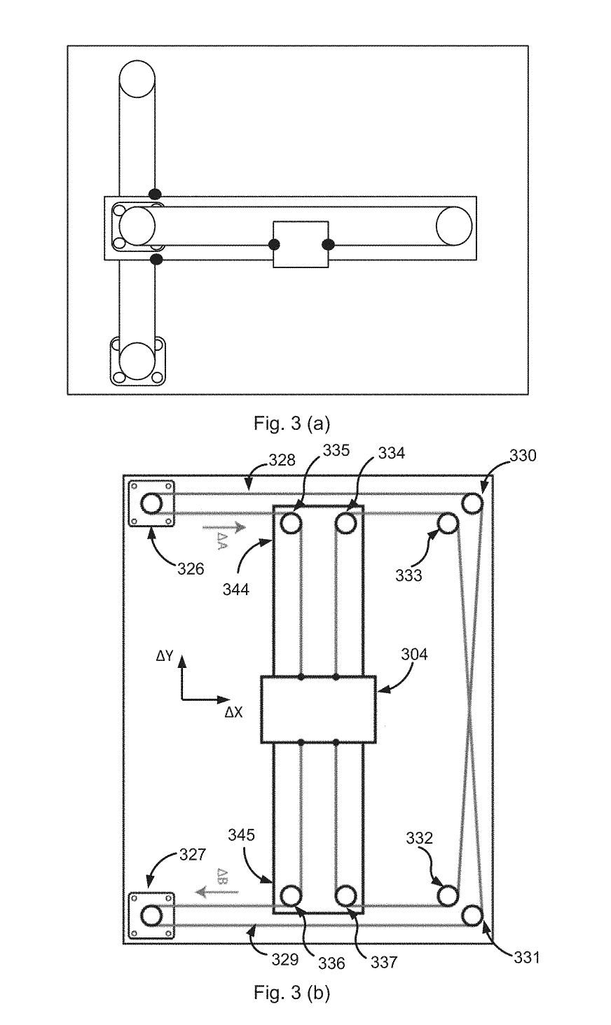

FIG. 3(a) is a schematic representation of a traditional gantry system;

FIG. 3(b) is a schematic representation of the CoreXY gantry system used in the present invention;

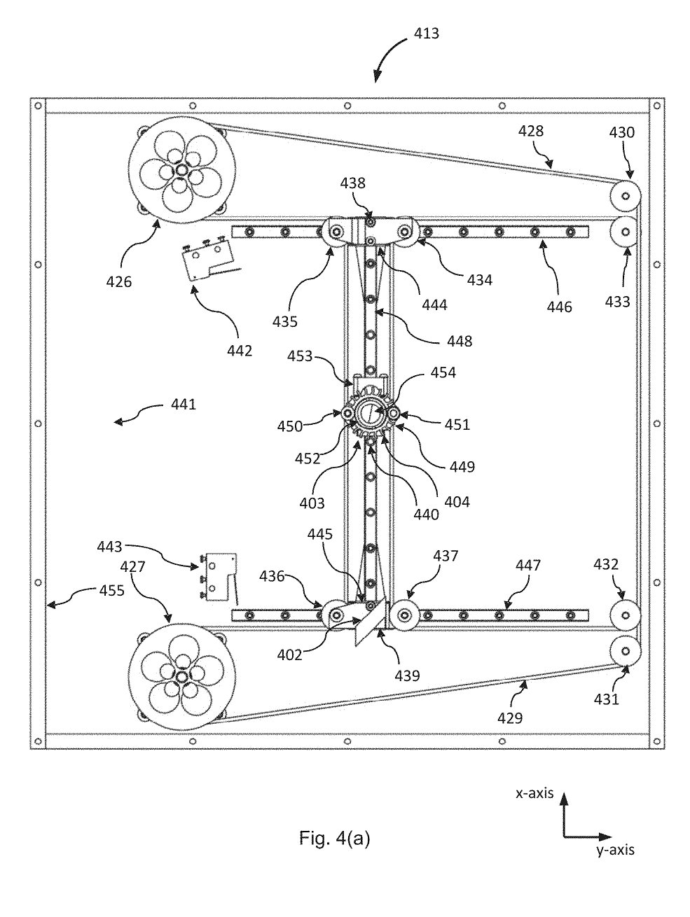

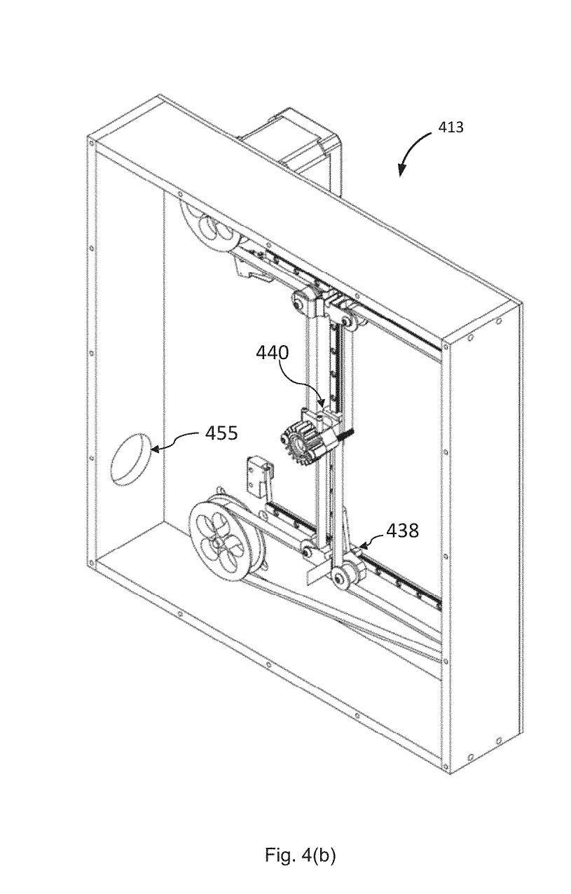

FIG. 4(a) illustrates a plan view of the optical enclosure of an embodiment of an SLM device with a CoreXY gantry system;

FIG. 4(b) illustrates a side view of the optical enclosure of an embodiment of an SLM device with a CoreXY gantry system;

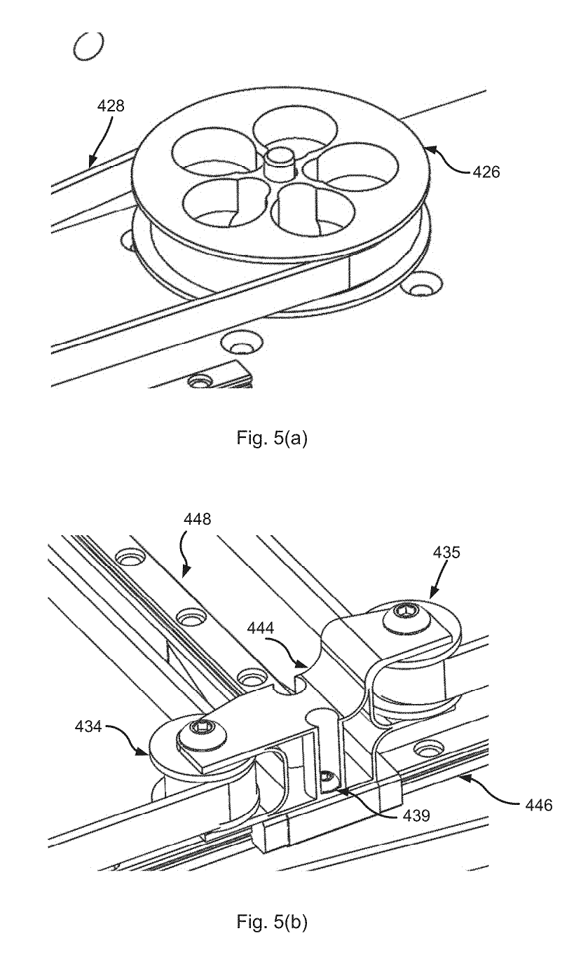

FIG. 5(a) illustrates an exemplary drive pulley in the CoreXY gantry system; FIG. 5(b) illustrates an exemplary carriage in the CoreXY gantry system;

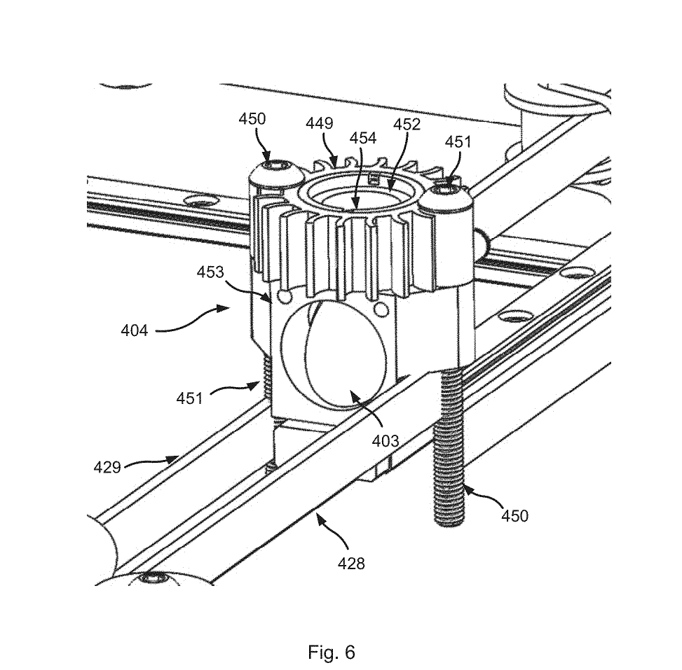

FIG. 6 illustrates an exemplary scan head of the SLM device;

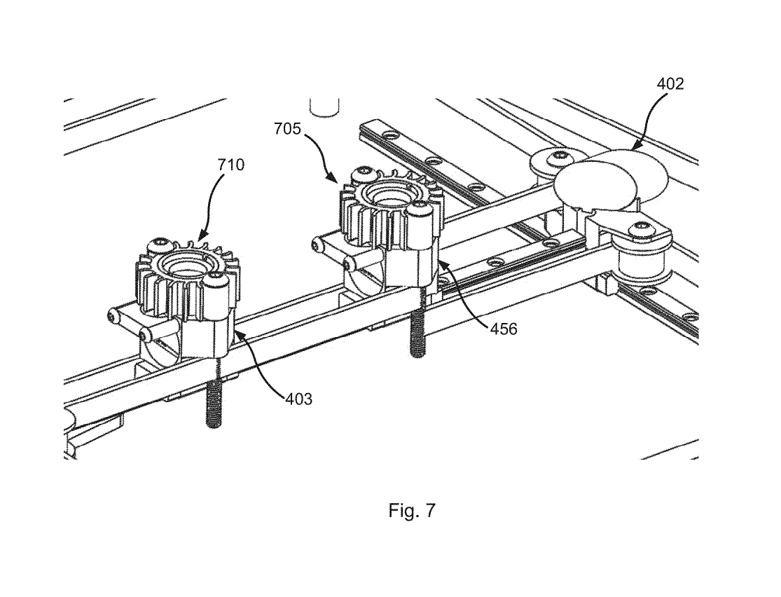

FIG. 7 illustrates an alternative configuration having two scan heads, in which a secondary mirror of a first scan head is replaced by a beam splitter;

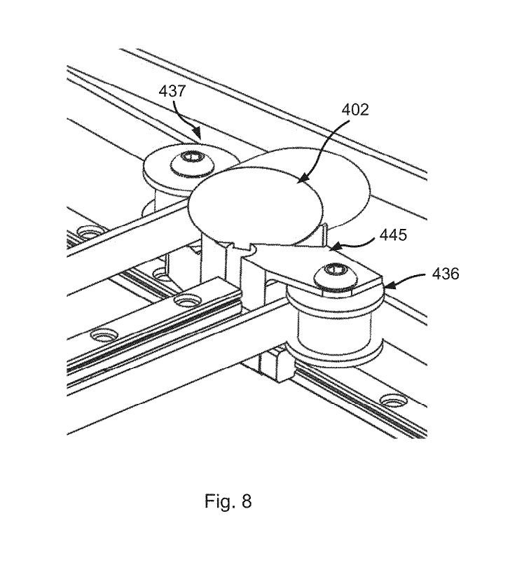

FIG. 8 illustrates an exemplary second type of carriage used in the system;

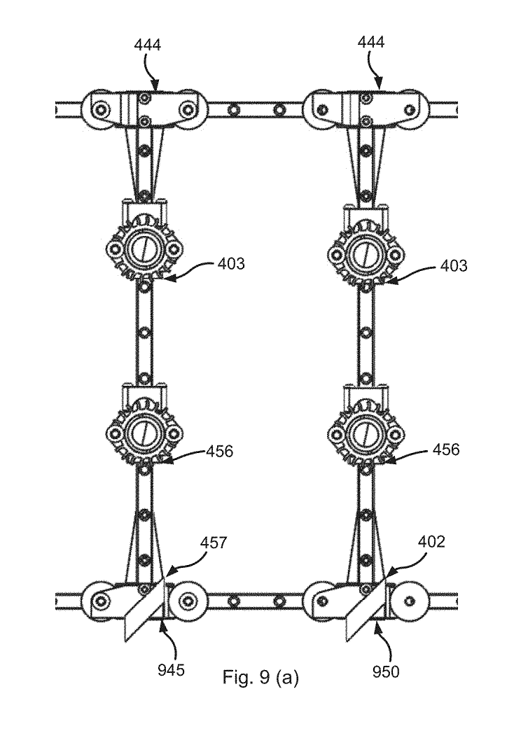

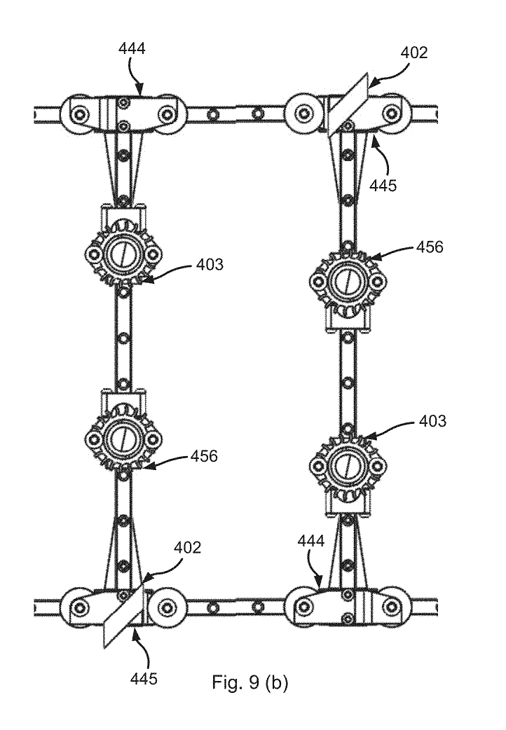

FIG. 9(a) illustrates a plan view of a passive configuration having four scan heads in which a primary mirror is replaced by a beam splitter;

FIG. 9(b) illustrates a plan view of an alternative configuration in which scan heads are multiplied in the x-direction in an active configuration;

FIG. 10 illustrates an exemplary carriage of a first type;

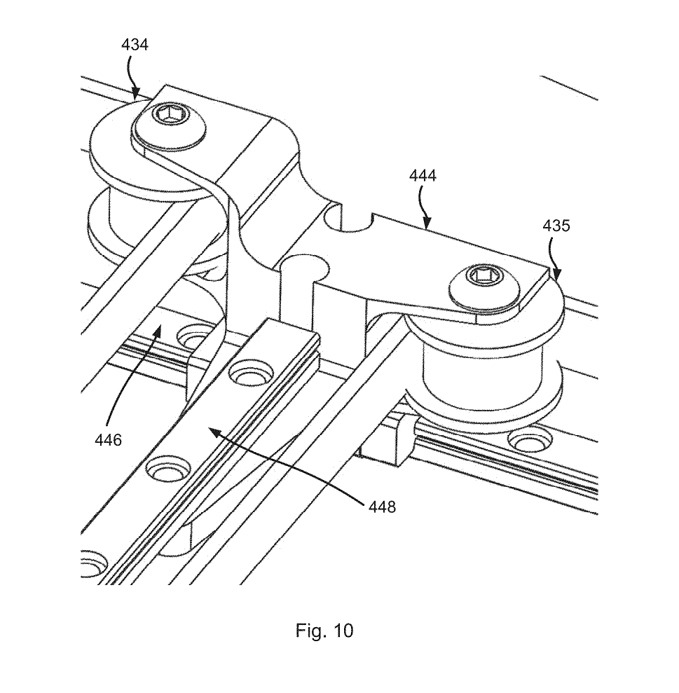

FIG. 11 illustrates the fixed idler pulleys of the gantry system;

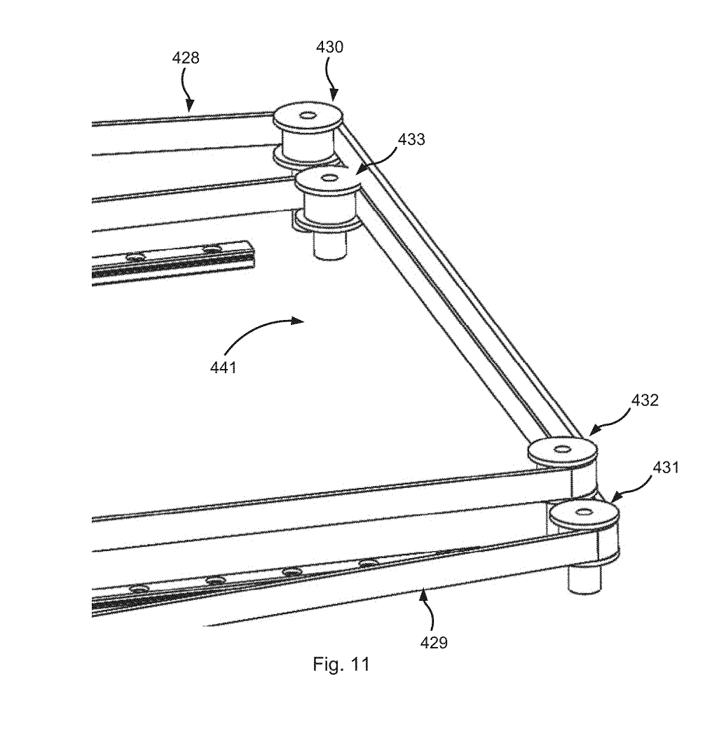

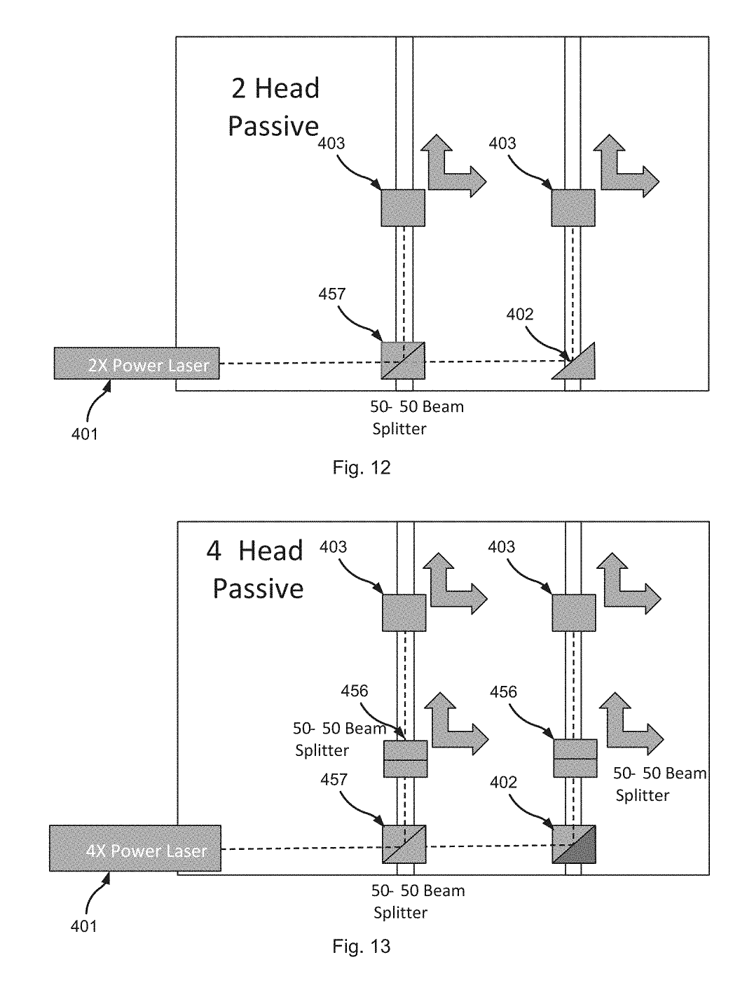

FIG. 12 is a schematic representation of an embodiment with a 2-head passive configuration;

FIG. 13 is a schematic representation of an alternative embodiment with a 4-head passive configuration;

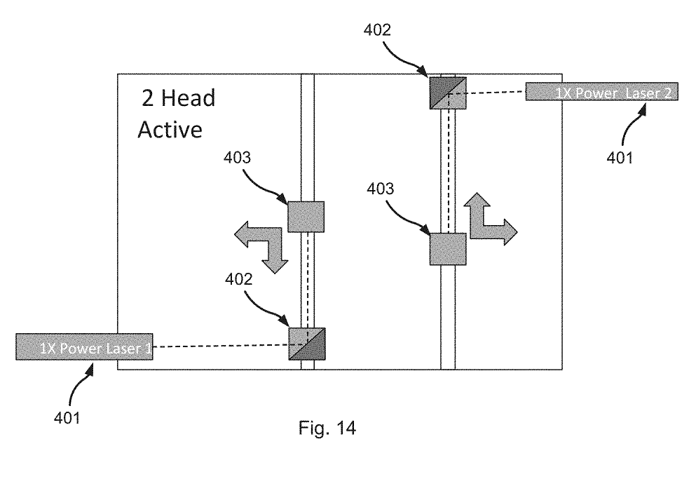

FIG. 14 is a schematic representation of an alternative embodiment with a 2-head active configuration;

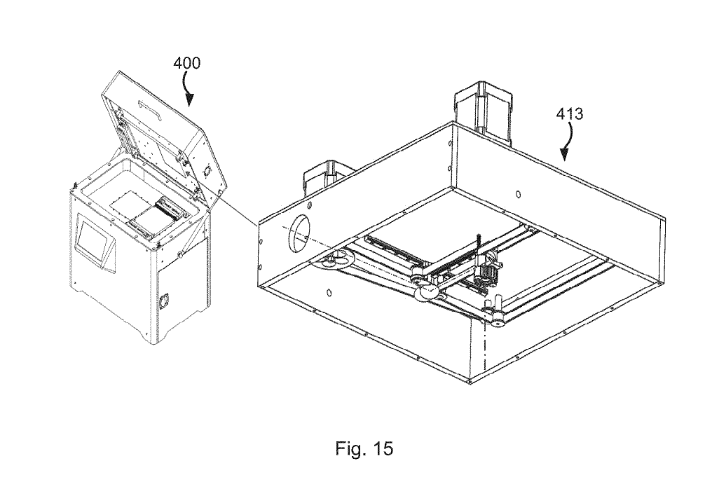

FIG. 15 illustrates the optical enclosure within the XM200 demo model of the scanner, and

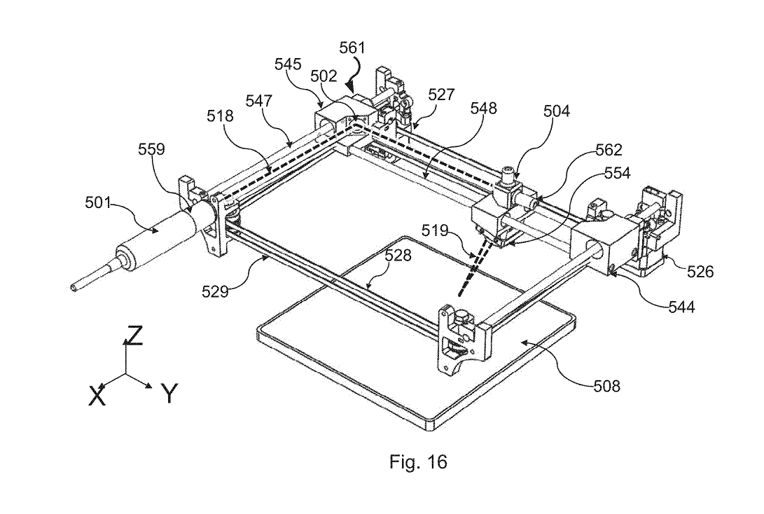

FIG. 16 illustrates a hybrid scanner incorporating a galvanometer based deflection system and a Core-XY gantry system.

### DETAILED DESCRIPTION OF THE PREFERRED EMBODIMENTS

FIG. 2 is a schematic representation of an embodiment of an SLM machine. Various components of the SLM machine are listed below using the reference numerals used in the figure:
200) AM machine
201) Collimated light source
202) Primary mirror
203) Secondary mirror
204) Scan head
205) Removable build plate
206) Feed platform
207) Feed cylinder
208) Build platform
209) Build cylinder
210) Catch bin
211) Coating mechanism
212) Ventilation manifold
213) Optical enclosure
214) Optically transparent window
215) Build chamber enclosure
216) Feeder linearly actuated screw
217) Build linearly actuated screw
218) Collimated beam
219) Focused beam
220) Scanner drive motors
221) Feedstock powder
222) Solidified 3D part
223) Unfused powder bed
224) Overflow powder
254) Focal lens

In the embodiment of FIG. 2, the machine 200 comprises a feeder (not shown) that can be used to deliver feedstock powder 221 to the process. The feeder device comprises of a feed cylinder 207, a feed platform 206, and a feeder linearly actuated screw 216. The parts that are to be built are built on a removable build plate 205 located upon the build platform 208. The build plate 205 is a flat two-dimensional plate used as a stage to build the parts on top of. The build platform 208 is housed within a build cylinder 209. The build cylinder 209 comprises an extruded shape that compliments the external dimensions of the build platform 208. The build cylinder 209 provides a barrier for the unused feedstock powder while the build process is taking place. The build platform 208 is located on the build linearly actuated screw 217. This screw 217 adjusts the height of the build platform 208. In this example, the build platform and build plate form part of the structure in which the target area for 3D printing is formed.

The feed platform 206 and build platform 208 are located in the hermetically sealed build chamber enclosure 215. At one end of the build chamber enclosure 215 there is a coating mechanism 211 that is used to evenly spread the feedstock powder over the build platform 208. Situated at the opposite end of the build chamber is a catch bin 210 used to catch the overflow powder 224. A ventilation manifold 212 is used to circulate inert gas within chamber 215.

Above the build chamber enclosure 215 is the optical enclosure 213. A collimated light source 201 produces a collimated beam 218 that enters the optical enclosure 213. The beam is reflected by a primary mirror 202 and then reflected by a secondary mirror 203. A focussing lens 254 is mounted in the scan head 204 and produces a focused beam 219. The beam 219 then passes through an optically transparent window 214. The beam melts powder on the build plate 205 to produce a solidified 3D part 222.

In one embodiment, before operation a 3D CAD model is generated in modelling software. This CAD model is exported as a .STL file and imported into the AM software. The AM software orients and slices the model according to processing parameters such as laser power, infill spacing, and scan speed. The AM software then generates a .gcode file that is then sent and interpreted by the AM machine.

The preparation of the machine involves several steps:
1. Loading the gcode to the onboard computer;
2. Filling the dispenser/feeder with feedstock powder 221;
3. Installing a clean build plate 205 and ensuring that it is level with the recoating mechanism and focal plane;
4. Checking and/or cleaning the optical components of debris;
5. Closing and securely sealing the build chamber enclosure 215;
6. Enabling the heated bed so that it may warm up the build plate 205 to an ideal processing temperature to reduce thermal stresses in the build;
7. Flooding the build chamber enclosure 215 and ventilation system with an inert gas such as Argon until the O2 limit within the chamber reads below the allowable limit;
8. Once the O2 limit is reached, the ventilation system can be powered on to remove weld spatter and particulates from the process by filtering and recycling the gas in the chamber;
9. Finally the build is ready to be initiated.

Once the build has been initiated, the AM machine begins executing the gcode commands.

The build process is made up of a succession of layer depositions that occur as follows:
1. The build plate 205 drops below the build plane by one layer height (approx. 10 to 100 microns);
2. The feeder dispenses powder 221 for the coating mechanism 211 to push across the build plane and the excess powder drops into the catch bin 210 on the other side;
3. The coating mechanism 211 returns to its original position as the build plate 205 and feeder drop a small distance to avoid being affected by the returning device;
4. The build plate 205 and feeder return to their original positions and the fusing process may begin;
5. The laser scan head 204 moves into its starting position and begins fusing the cross section of the layer as the laser begins irradiating and the head 204 begins to scan the patterns according to the gcode;
6. The laser scanner 204 will complete different types of patterns in order to achieve the types of part properties desired as is determined by the defined processing parameters;
7. Once the laser scanner 204 is finished with the layer it stops emitting radiation and the process repeats at step 1, but with a slightly new pattern based on the cross sectional geometry of the following layer.

The operator may monitor the build process with a camera that is mounted inside of the scanner and observes the process from a safe location.

The process will complete when the machine executes the gcode for every layer so printing time estimates can be calculated and displayed on the user interface.

Once the process is complete, the build cools down and then the operator may remove the build by brushing away unused powder 223 and removing the build plate 205 from the build platform 208.

The parts are then ready for post-processing which may vary depending on build material. Some parts may be heat treated, hot-isostatically pressed (HIPed), and then removed from the build plate 205 by cutting or using some other process such as wire-EDM.

The build plate 205 must be resurfaced before being reused and the unused powder from the process must be sieved to remove agglomerates or otherwise non-ideal particles.

The parts are now ready for use or other types of post-process machining operations.

FIG. 3(a) is a schematic representation of a traditional gantry system. The traditional gantry system has a dedicated motor and belt for each direction of movement. In this system one of the motors moves along one of the axes.

FIG. 3(b) is a schematic representation of the CoreXY gantry system used in the present invention. The CoreXY style of the gantry system uses parallel kinematics to move a carriage in two dimensions of Cartesian space. The gantry has two motors 326, 327 that are connected to two belts 328, 329. The system has four fixed idler pulleys 330, 331, 332, 333 located on the opposite side of the optical enclosure to the two drive motors 326, 327. The two drive motors 326, 327 and the first and second fixed pulleys 330, 331 form the corners of a quadrilateral. The third and fourth fixed pulleys 332, 333 are closer to the centre of the optical enclosure than the first two fixed pulleys 330, 331. There are four further idler pulleys 334, 335, 336, 337 that are attached to two movable carriages 344, 345. It will be appreciated that, in this example, these two movable carriages 344, 345 are discrete carriages, but they can also form part of a same carriage. Located between the two carriages is a movable scan head 304. The drive belt 328 runs from the movable scan head 304 round the second carriage pulley 335 and to the first drive pulley 326. From the first drive pulley 326 the belt runs to the first fixed pulley 330, across to the third fixed pulley 332, round the fourth carriage pulley 337 and then to the movable scan head 304. The second belt 329 then runs from the movable scan head, round the remaining pulleys, in a way symmetrical to the way described above. Inertia in this system is minimised as the motors in this system are stationary, allowing for quick and precise accelerating movements. This gantry system provides the ability to achieve much faster and much more controlled motion due to the reduction of mass moving with the gantry.

In use, when both the motors are rotating at the same speed and in the same direction, the scan head will move in the y-axis (or vertical direction) only. When both motors rotate at the same speed in opposite directions, the scan head will move only in the x-axis (or horizontal direction). This motion is governed by the parallel kinetic motion equations:

ΔY=½(ΔA+ΔB)

ΔX=½(ΔA−ΔB)

ΔA=ΔX+ΔY

ΔB=ΔY−ΔX

These parameters and directions are shown in FIG. 3(b). Through the use of the parallel kinematic motion equations, a computer may control the speed and position of the motors to move the scan head in the desired paths based on the instruction codes.

FIG. 4(a) illustrates a plan view of the optical enclosure 413 of an embodiment of a SLM device with a CoreXY gantry system. Various components of the SLM machine are listed below using the reference numerals used in the figure:
402) Primary Mirror
403) Secondary Mirror
404) Scan Head
413) Optical Enclosure
426) Drive Pulley 1
427) Drive Pulley 2
428) Timing Belt 1
429) Timing Belt 2
430) Idler Pulley 1
431) Idler Pulley 2
432) Idler Pulley 3
433) Idler Pulley 4
434) Idler Pulley 5
435) Idler Pulley 6
436) Idler Pulley 7
437) Idler Pulley 8
438) Linear Bearing 1
439) Linear Bearing 2
440) Linear Bearing 3
441) Optical Substrate
442) Limit Detector 1
443) Limit Detector 2
444) Carriage 1
445) Carriage 2
446) Linear Rail 1
447) Linear Rail 2
448) Linear Rail 3
449) Focal Lens Mount
450) Belt Anchor 1
451) Belt Anchor 2
452) Focal Lens Retainer
453) Secondary Mirror Clamp
454) Focal Lens
455) Laser Entry Point

The CoreXY gantry system is mounted on an optical substrate 441 within the optical enclosure 413. The gantry system comprises first and second drive pulleys 426, 427, first, second, third and fourth fixed idler pulleys 430, 431, 432, 433, and first, second, third and fourth carriage pulleys 434, 435, 436, 437. First and second timing belts 428, 429 connect the idler pulleys 430, 431, 432, 433, 434, 435, 436, 437 to the drive pulleys 426, 427 and scan head 404. First and second carriage pulleys 434, 435 are located on a carriage of a first type 444. Third and fourth carriage pulleys are located on a carriage of a second type 445. The carriage of a first type 444 is movable in the x-direction along the first linear rail 446 using the first linear bearing 438. The carriage of a second type 445 is movable in the x-direction along the second linear rail 447 using the second linear bearing 439. A third linear rail 448 is located between the first and second carriages 444, 445. The scan head 403 is movable in the y-direction along the third linear rail 448 using a third linear bearing 440.

In use, the laser enters the optical enclosure 413 through the laser entry point 455. The laser beam is then reflected by the primary mirror 402 located on the carriage of a second type 445. The laser beam is then reflected by the secondary mirror 403 located within the scan head 404. The beam is then focussed onto the build plane using the focal lens 454 within the scan head 404.

First and second limit detectors 442, 443 are located within the optical enclosure 413 to allow the computer controller to detect where the scanner is in a two dimensional space.

FIG. 4(b) illustrates a side view of the optical enclosure 413 of a SLM device with a CoreXY gantry system.

FIG. 5(a) illustrates an exemplary drive pulley 426, 427 in the CoreXY gantry system and FIG. 5(b) illustrates an exemplary carriage 444 in the CoreXY gantry system.

The acceleration of the gantry system is dependent upon the linear inertia of the gantry and the rotational inertia of the pulleys and motor system. The linear and rotational inertia is generally reduced (minimized) as much as possible to attain rapid accelerations. Advanced manufacturing methods are used to reduce this inertia by creating structures that have a high strength-to-mass ratio. Lightweight materials such as aluminium or titanium may be used for fabricating the gantry components including the carriages, pulleys, scan heads and lens mounts. Hardened steel may be used for the linear rails due to its resistance to wear and high degree of rigidity.

High precision is attained by the use of precision motion components such as the linear carriages and rails that are used to guide the gantry components. The small size of these components reduces mass. Yet their design reduces ‘play’ in the system and maintains the perpendicularity of the x and y axis.

FIG. 6 illustrates an exemplary scan head 404 of the SLM device. The scan head 404 is connected to the ends of the first and second belts 428, 429 which synchronise the scan head 404 with the motion of the two drive motors. The ends of the belts are secured to the scan head 404 using belt anchors 450, 451. The way the scan head 404 is connected to the belts 428, 429 reduces (minimises) the amount of dynamic and static stress induced in the body of the scan head 404 so that it does not distort significantly before, during, or after use.

The screws 450, 451 that are used as belt anchors are also used to the secure the lens mount 449 to the scan head body 404. This reduces (minimises) part count, part complexity, and weight, while maintaining rigidity and reliability. The lens mount 449 secures the focal lens 454 to the scan head 404. The lens mount 449 may have a threaded internal cavity to allow a lens retaining ring 452 to retain the lens 454 inside the mount 449.

The absorption of a small percentage of the high powered laser energy transmitted through the lens 454 could cause the focal lens 454 to heat up. Cooling fins may be integrated into the lens mount to allow the dissipation of heat into the atmosphere. Fans may be included in the optical enclosure, actively cooling the lens. These force air over the fins of the scan head. This feature significantly improves thermal stability.

In this example, the secondary mirror 403 is secured in the scan head using the secondary mirror clamp 453. The secondary mirror 403 fits inside of the scan head 404 directly in the line propagation of the laser beam from the primary mirror at the end of the axis. The secondary mirror 403 is positioned such that the reflecting surface is generally at approximately a 45 degree angle from the direction of beam propagation. The beam then reflects from the secondary mirror 403 to the focal lens 454.

FIG. 7 illustrates an alternative configuration having two scan heads, in which a secondary mirror of a first scan head is replaced by a beam splitter 456. The beam splitter 456 is a partially reflecting, partially transparent surface that allows the beam to be split into two beams of inversely proportional power levels defined by the preparation of the incident surface. This allows for one of the beams, the reflected beam, to propagate along the original path and through the focal lens of a first scan head 705. The other beam, the transmitted beam, is incident with the secondary mirror 403 of a second scan head 710 and propagates through the focal lens of the second scan head 710.

It would be appreciated that the secondary mirror of the second scan head may be replaced with a beam splitter. In this way it is possible to increase the number of scan heads indefinitely in the y-direction. This configuration is a passive configuration as all scan heads in this configuration have the same output.

FIG. 8 illustrates an exemplary second type of carriage 445 used in the system. The primary mirror 402 is securely mounted to the carriage 445. The primary mirror 402 is generally directly in the path of the collimated laser beam. The reflecting surface of the primary mirror is generally approximately 45° from the direction of beam propagation. Broadly speaking, the carriage 445 rigidly mates the y-axis perpendicular to the x-axis. The carriage 445 is movable in the x-direction. The carriage 445 routes the drive belts to the scan head using idler pulleys 436, 437.

FIG. 9(a) illustrates a plan view of a passive configuration having four scan heads in which a primary mirror is replaced by a beam splitter 457. This allows the beam to be split into two beams of inversely proportional power levels defined by the preparation of the incident surface of the beam splitter 457. One of the beams, the reflected beam, will propagate along the original path to the secondary mirror or beam splitter of a scan head located on the same linear rail as a first carriage 945. The other beam, the transmitted beam, is incident with a second primary mirror 402 on a second carriage 950. This beam will propagate to a scan head located on the same linear rail as the second carriage.

It would be appreciated that, the second primary mirror may be replaced by another beam splitter. In this way it is possible to increase the number of vertical gantries, and scan heads, indefinitely in the x-direction. This configuration is a passive configuration as all scan heads in this configuration have the same output. FIG. 9(b) illustrates a plan view of an alternative configuration in which scan heads are multiplied in the x-direction in an active configuration. A second vertical gantry is rotated 180° such that the carriage of a first type 444 of a first vertical gantry is located on the same linear rail as a carriage of a second type 445 of a second vertical gantry. This allows two independent laser beams to propagate separately to primary mirrors 402 on the two carriages of a second type 445. The laser beams then propagate to secondary mirrors 403 or beam splitters 456 of scan heads. This is an active configuration as scan heads on different vertical gantries can have different outputs.

FIG. 10 illustrates an exemplary carriage of a first type 444. The carriage 444 generally rigidly mates a vertical linear rail 446 of a gantry perpendicular to a horizontal linear rail 448. The carriage 444 routes the belts to the scan head using the idler pulleys 434, 435. The carriage 444 is designed to reduce (minimise) mass and improve (maximise) rigidity. Alternate configurations of the carriage may require additional pulleys in order to route additional drive belts to multiple scan heads.

FIG. 11 illustrates the fixed idler pulleys 430, 431, 432, 433 of the gantry system. The fixed idler pulleys route the drive belts 428, 429 to the drive pulleys and the carriages. The fixed idler pulleys 430, 431, 432, 433 are rigidly mounted to the optical substrate 441 in order to provide precise guidance of the belts to the carriages. Generally speaking, the placement of the pulleys 430, 431, 432, 433 is precise so that the tension in the belt does not vary as the scanner traverses. This means that the portion of the belt between a drive pulley and fixed idler pulley, on which a carriage is attached, is routed parallel to the x-direction of motion.

FIG. 12 is a schematic representation of an embodiment with a 2-head passive configuration. This configuration uses a single laser 401 of 2X power where X is the power used in a single scan head. A first primary mirror is replaced with a beam splitter 457 that splits the beam into two laser beams of approximately equal power. The beams propagate to two scan heads on separate gantries. The configuration is a passive configuration as both scan heads have about identical laser outputs.

FIG. 13 is a schematic representation of an alternative embodiment with a 4-head passive configuration. This configuration uses a single laser 401 of 4X power where X is the power used in a single scan head. A first primary mirror is replaced with a beam splitter 457 that splits the beam into two laser beams of equal power. Secondary mirrors of first scan heads of two gantries are replaced with beam splitters 456. These beam splitters split each of the two laser beams into two laser beams of equal power. It will be appreciated that in this example, beams splitters 456 are located on scan heads (not shown) and secondary mirrors 403 are located on other scan heads (not shown). The two reflected beams propagate through the first scan heads. The two transmitted beams propagate to secondary mirrors 403 and through the second scan heads. This configuration is a passive configuration as all four scan heads have about identical laser outputs.

FIG. 14 is a schematic representation of an alternative embodiment with a 2-head active configuration. This configuration uses two lasers of 1X power where X is the power used in a single scan head. Two primary mirrors 402 are arranged on two separate gantry devices such that the primary mirrors 402 are at opposite ends of the gantry devices to each other. One laser beam is incident upon each primary mirror 402, and propagates to a secondary mirror 403 and to each focal lens. This configuration is an active configuration as each scan head can have a different laser output.

FIG. 15 illustrates the optical enclosure 413 within the XM200 demo model of the scanner.

Exemplary technical data of the XM200 is as follows:

| | |
|---|---|
| Build Volume | 125 in³ (5 × 5 × 5 in) |
| | 2049 cc (127 × 127 × 127 mm) |
| Exterior Dimensions | Approx. 610 × 610 × 1295 mm² |
| | (24 × 24 × 51 in³) |
| Laser Type | Quality 250 W fiber laser |
| Precision Optics | Spot size greater than 10 microns |
| Fusing Speed | Up to 1.5 m/s with orthogonal high-speed scanner |
| Electrical | Power Supply 220 V (50-60 Hz) |
| | Consumption 2500 W (12 Amps) |
| User Interface | 7″ intuitive touch screen |
| Weight | Approximately 500 lbs (227 kgs) |
| Powder Options | 316 L Stainless Steel, Inconel 718 Superalloy, |
| | Titanium 6Al 4 V, Aluminum Si10 Mg, Maraging |
| | Steel |

The advantages of this scanner and generally of the claimed apparatus are as follows:
The scanner has a large build volume, allowing the printing of multiple parts more efficiently and quickly.
The high-speed scanner fuses at speeds up to 1.5 meter/sec. The beam is constantly orthogonal across the entire powder bed surface, which produces consistent fusing properties throughout the entire build area.
A 250W fiber laser prints 20-100 μm layers with a spot size greater than 10 microns, allowing parts to be built with precision.
A small printer footprint makes it easier to include additive manufacturing in a factory, lab or facility.
The build chamber is easy to set up, quick to purge, and simple to clean and maintain.
Modern software architecture offers a streamlined, intuitive, and functional platform that supports visual workflows. Cloud connectivity of one or more printers is also available, allowing monitoring of the printing process from anywhere.

FIG. 16 illustrates a hybrid scanner incorporating a galvanometer based deflection system and a Core-XY gantry system. Various components of the hybrid scanner are listed below using the reference numerals used in the figure:
501) Collimating laser light source
502) Primary Mirror
504) Galvanometer scanner body
508) Build/focal plane
518) Collimated beam
519) Focused beam
526) Drive motor 1
527) Drive motor 2
528) Timing belt 1
529) Timing belt 2
544) Carriage 1
545) Carriage 2
547) X-axis linear rail
548) Y-axis linear rail
554) F-theta lens
559) Collimator aperture
561) Primary mirror galvanometer motor
562) Secondary mirror galvanometer motor

In the hybrid scanner the scan head is replaced with a small galvo scanner body 504. A first galvanometer motor 561 rotates the primary mirror 502. A second galvanometer 562 motor rotates the secondary mirror (not shown). An f-theta lens 554 is used within the scanner body 504 to focus the beam on the build plane 508. A collimator aperture 559 may be attached to the collimating laser light source 501. This embodiment provides the unconstrained build area dimensions arising from using the Core-XY gantry system with the high scanning and positioning speeds of a galvo scanner. Until a conventional galvo scanner, this embodiment minimises the AOI as the scanner does not need to deflect the beam very far. The scanner uses small deflection angles to scan small areas quickly, while the gantry system simultaneously moves the scanner across the build plane 508. This has the advantage that the mass of the moving parts of the galvo scanner is not a problem as the gantry does not need to move as rapidly as in the previous embodiments. The galvo scanner may replace the scan head in any active configuration of the machine.

Although the invention has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein.

1. An apparatus for an additive manufacturing process, the apparatus comprising:
a structure for providing a target area for producing a three dimensional (3D) part;
a gantry device located on top of the target area of the structure, wherein the gantry device comprises:
a first primary reflecting element for receiving a collimated beam from a light source;
a first secondary reflecting element for receiving at least a portion of said collimated beam from the first primary reflecting element;
a first scanner comprising a focal element for directing the at least a portion of said collimated beam to the target area;
wherein the apparatus further comprises a controller configured to move the first scanner of the gantry device over the target area in a first direction along a longitude of the apparatus and in a second direction transverse to the first direction.

2. An apparatus according to claim 1, wherein the controller is configured to move the first scanner in two dimensions of Cartesian space over the target area.

3. An apparatus according to claim 1, wherein the controller is configured to move the first scanner over any location of the target area.

4. An apparatus according to claim 1, wherein the first secondary reflecting element is positioned such that a reflecting surface is about 45° angle from a direction of beam propagation from the first primary reflecting element.

5. An apparatus according to claim 1, wherein the first primary reflecting element and the first secondary reflecting element each are a reflecting mirror.

6. An apparatus according to claim 1, wherein the gantry device further comprises:
a first longitudinal rail;
a first carriage moveable along the first longitudinal rail along the first direction;
a second longitudinal rail;
a second carriage moveable along the second longitudinal rail along the first direction;
a first vertical rail unit connecting the first and second carriages and extending in the second direction, wherein the first scanner is moveable in the first direction when the first and second carriages move in the first direction, and wherein the first scanner is moveable along the first vertical rail unit in the second direction.

7. An apparatus according to claim 6, wherein the first primary reflecting element is coupled with the first carriage and the first secondary reflecting element is coupled with the first scanner.

8. An apparatus according to claim 6, comprising a second scanner on the first vertical rail unit, wherein the second scanner comprises a second secondary reflecting element.

9. An apparatus according to claim 8, wherein the first primary reflecting element is a reflecting mirror and wherein the first secondary reflecting element is a beam splitter and wherein the second secondary reflecting element is a reflecting mirror or wherein the second secondary reflecting element is a beam splitter.

10. An apparatus according to claim 6, further comprising:
a third carriage moveable along the first longitudinal rail along the first direction;
a fourth carriage moveable along the second longitudinal rail along the first direction;
a second vertical rail unit connecting the third and fourth carriages extending in the second direction.

11. An apparatus according to claim 10, further comprising a second primary reflecting element coupled with the third carriage.

12. An apparatus according to claim 11, further comprising a third scanner moveable on the second vertical rail and a third secondary reflecting element coupled with the third scanner, and wherein the first primary reflecting element is a beam splitter, and wherein the second primary reflecting element is a reflecting mirror and the third second reflecting element is a reflecting mirror.

13. An apparatus according to claim 11, further comprising a fourth scanner moveable on the second vertical rail and a fourth secondary reflecting element coupled with the fourth scanner, and wherein the first primary reflecting element is a beam splitter, and wherein the second primary reflecting element is a reflecting mirror, and wherein the third secondary reflecting element is a beam splitter, and wherein the fourth secondary reflecting element is a reflecting mirror.

14. An apparatus according to claim 10, further comprising:
a second primary reflecting element coupled with the fourth carriage, and
a third scanner moveable on the second vertical rail and a third secondary reflecting element coupled with the third scanner, wherein the second primary reflecting element is configured to receive a collimated beam from a further light source.

15. An apparatus according to claim 1, wherein the first and second reflecting elements do not rotate to an angle.

16. An apparatus according to claim 1, wherein the first scanner comprises a galvanometer based deflection device so that at least one of the first primary and secondary reflecting elements rotate.

17. An apparatus according to claim 1, further comprising a light source.

18. A three dimensional (3D) metal printer incorporating the apparatus of claim 1.

19. A system for additive manufacturing comprising:
at least one light source;
an apparatus according to claim 1.

20. A method of manufacturing an apparatus for an additive manufacturing process, the method comprising:
providing a structure having a target area for producing a three dimensional (3D) part;
providing a gantry device located on top of the target area of the structure, wherein the gantry device comprises:
a first primary reflecting element for receiving a collimated beam from a light source;
a first secondary reflecting element for receiving at least a portion of said collimated beam from the first primary reflecting element;
a first scanner comprising a focal element for directing the at least a portion of said collimated beam to the target area; and
providing a controller to move the first scanner of the gantry device over the target area in a first direction along a longitude of the apparatus and in a second direction transverse to the first direction.
